(19) United States
(12) Patent Application Publication
(10) Pub. No.: US 2016/0325994 A1
(43) Pub. Date: Nov. 10, 2016

(54) HIGH ASPECT BORON NITRIDE, METHODS, AND COMPOSITION CONTAINING THE SAME

(71) Applicant: MOMENTIVE PERFORMANCE MATERIALS INC., Waterford, NY (US)

(72) Inventors: Hao QU, Middleburg Heights, OH (US); Anand MURUGAIAH, Strongsville, OH (US); Bei XIANG, Strongsville, OH (US); Chandrashekar RAMAN, Sheffield Village, OH (US); Kang YI-LIN, Zhongli City (CN)

(21) Appl. No.: 15/109,869

(22) PCT Filed: Jan. 5, 2015
(86) PCT No.: PCT/US15/10122

§ 371 Date: Jul. 6, 2016

Related U.S. Application Data
(60) Provisional application No. 61/923,974, filed on Jan. 6, 2014.

(51) Int. Cl. C01B 21/064; C09K 5/10; C08K 3/38; C09D 1/00; H01B 3/02; C10M 125/26; C09K 5/14; C09D 5/08

(52) U.S. Cl. CPC C01B 21/0648; C09K 5/14; C09K 5/10; C09D 5/084; C09D 1/00; H01B 3/02; C10M 125/26; C08K 3/38; C01P 2004/54; C01P 2004/62; C01P 2004/61; C01P 2006/12; C10M 2201/087; C10N 2220/082; C08K 2003/385

(57) ABSTRACT

A multi-functional composition including high aspect boron nitride particles providing improved properties such as thermal conductivity, electrical insulation, barrier to moisture, vapor, and gasses, lubrication, friction modification, optical properties, suspension stability, and a system and method for forming such compositions. The high boron nitride particles have an average aspect ratio greater than 300. The multifunctional composition may comprise of a polymer material, fluids, metals, ceramics, glasses, other non-BN fillers and the high aspect ratio boron nitride. Also provided are methods for making such boron nitride particles and compositions.

### CROSS REFERENCE TO RELATED APPLICATIONS

This application claims priority to U.S. Provisional Application No. 61/923,974, filed on Jan. 6, 2014 entitled “High Aspect Boron Nitride, Methods, and Composition Containing the Same,” the disclosure of which is incorporated herein by reference in its entirety.

### FIELD

The present subject matter provides high aspect ratio boron nitride particles, compositions comprising the same, and methods for making such particles and compositions. The present subject matter also provides a method for forming multi-functional compositions comprising high aspect boron nitride platelets with properties such as, but not limited to, thermal conductivity, electrical insulation, barrier to gas/moisture, optical materials, lubrication/friction modification, crystal nucleation, etc.

### BACKGROUND

Thermal management of various electronic and opto-electronic devices is increasingly challenging due to the trend of shrinking sizes and increased functionality, such as in personal hand-held electronic devices. The power density, and hence the density of heat that needs to be dissipated, have significantly increased, which poses significant challenges to providing good thermal management in those devices. An increase in miniaturization and higher performance processors (such as, for example, tablets, smart phones, etc.) has resulted in a substantial increase in thermal loads and a reduction in area available to dissipate increased heat. Thermal management problems are also widely prevalent in other applications such as LEDs, electronic components in automotives, rechargeable battery systems, power inverters for hybrid vehicles, etc. Insufficient or ineffective thermal management can have a strong and deleterious effect on the performance and long-term reliability of devices.

These problems create a need for thermal management materials, such as thermal interface materials, thermally conductive polymers, LED encapsulants, etc., having conductive properties better than what is currently available. Currently available fillers are limited in their performance and generally not sufficient to satisfy these increased demands. Several limitations exist with current boron nitride fillers to achieve high performance in composite systems, fluids, and solids. Boron nitride has numerous properties of interest, including enhanced thermal conductivity, electrical insulation, transparency to various wavelengths including optical spectrum, barrier to gas/moisture permeation, and also lubrication and wear, non-stick properties, neutron absorption and scattering, deep UV emission, and potential to improve mechanical properties. However, the cost of boron nitride is very high compared to possible alternative fillers. Lower cost composites for these applications can be obtained using cheaper fillers such as alumina, silica, magnesium oxide, zinc oxide, metal powders, glass, graphite, etc. These materials, however, require very high loadings resulting in other less desirable properties, such as hard and brittle compositions. Such compositions may not be utilized where hardness (or softness) is a performance criteria, such as in die attaches, thermal interface materials, etc., where addressing thermal expansion and contraction are important. Additionally, these fillers cannot match advantages provided by hexagonal boron nitride filled systems, such as non-abrasiveness, higher performance, and low density.

Carbon nanotubes and graphene fillers improve mechanical properties and surface finish. These materials, however, are electrically conductive and black, and therefore are undesirable where electrical insulation and flexibility in color are important. Boron nitride powders formed from via ball milling that have moderately high aspect ratios suffer from poor yields and therefore are also undesirable.

Additionally, current commercially available hexagonal boron nitride powders require high solid loadings in composites and fluids to obtain significant improvements in properties such as thermal conductivity. Such high loadings of these expensive fillers increase the cost of the composite and also adversely affect processing and mechanical properties. These attributes limit the adoption of h-BN to niche applications.

### SUMMARY

The present subject matter provides high aspect ratio boron nitride particles and compositions comprising such particles (in matrices such as polymers, metals, ceramics, fluids, etc.). The high aspect ratio boron nitride provided by the present subject matter allows for lower loadings of the fillers in the compositions and also provides improved performance properties compared to current fillers. This can provide materials with a lower cost-to-performance ratio than current fillers at similar loadings. Surface treatments and functionalization of the boron nitride also enables easier processing of these materials, and to further enhance the properties of these materials/composites.

The present subject matter provides a composition comprising high aspect ratio boron nitride particles. The composition provides excellent thermal conductivity and could also exhibit other desirable properties such as, for example, maintaining electrical isolation, improving barrier to moisture and gas in composites, friction modification, mechanical, and optical properties, or a combination of two or more thereof. The high aspect ratio hexagonal boron nitride particles are in the form of platelets.

In one aspect, the present subject matter provides a method for forming a thermally conductive composition comprising high aspect h-BN platelets. In one aspect, the present subject matter provides a method of producing thermally conductive compositions. The compositions comprise a polymer matrix and a thermally conductive filler.

In one embodiment, the thermally conductive filler in the composition is boron nitride. In one embodiment, the boron nitride can be chosen from semi-crystalline or turbostratic boron nitride, having randomly oriented layers (referred to as t-BN); boron nitride with crystalline layered hexagonal structure (referred to as h-BN); platelet boron nitride; born nitride agglomerated particles; or a combination thereof. In one embodiment, the boron nitride is chosen from a platelet, turbostratic form, hexagonal form, or mixtures of two or more thereof.

In another embodiment, a combination of fillers is employed to provide a composition exhibiting excellent thermal conductivity. In still another embodiment, a composition comprises functionalization additives that provide increased thermal conductivity and allow for the concentration of thermally conductive fillers to be minimized. The methods of processing the compositions such as uniformly dispersing the fillers, master batches also provide a method to produce compositions exhibiting high thermal conductivity.

In one embodiment, the composition provides good thermal conductivity in the in-plane direction, the through-plane direction or both, even at relatively low loadings of a thermally conductive filler such as boron nitride. This allows for production of thermally conductive compositions at an overall significantly reduced cost of ownership.

In another aspect, the present subject matter provides a thermally conductive composition comprising a polymer material, and a high aspect ratio filler dispersed in the polymer material, wherein the composition has an in-plane thermal conductivity of about 1 W/mK or greater.

In one aspect, the process for making a thermally conductive composition comprises a boron nitride filler material dispersed in a polymer matrix.

In one embodiment, the boron nitride particles have an average aspect ratio of greater than 300. In one embodiment, the boron nitride particles have an average aspect ratio of about 305 to about 2500, about 310 to about 2000, about 325 to about 1500, about 350 to about 1000, even about 400 to about 800.

In one embodiment, at least 25% of the boron nitride particles have an average aspect ratio of greater than 300.

In one embodiment, the boron nitride particles have a surface area of from about 5 m²/g to about 500 m²/g, about to m²/g to about 250 m²/g, about 15 to about too m²/g, or about 20 m²/g to about 100 m²/g.

In one embodiment, the boron nitride particles have an oxygen content from about 0.01 to about 2.5 wt. %. In one embodiment, the boron nitride particles comprise at least h-BN particles having a graphitization index of less than 7.

In one embodiment, the boron nitride particles comprise of crystalline or partially crystalline boron nitride particles.

In one embodiment, the process produces h-BN particles using a mechanical exfoliation method. In one embodiment, the h-BN particles may be pre-treated before mechanical exfoliation to enhance susceptibility for exfoliation.

In one embodiment, the boron nitride material comprises high aspect ratio boron nitride particles and boron nitride agglomerates.

In one embodiment, high aspect ratio BN may be formulated by use of various matrix systems, thermosets, thermoplastics, or a combination of these; in metals, ceramics, glasses and other in inorganic materials; in greases, pastes, and suspensions, fluids, organics in aqueous systems or a combination of one or more. In one embodiment, h-BN is surface treated to provide specific groups on the surface that may then be directly used with any one or more of the above material systems, or the material systems can be additionally functionalized to be compatible with a BN surface or surface treated BN.

In one embodiment, suitable fillers, such as ceramic powders (e.g., alumina, silica, aluminum nitride, zinc oxide, magnesium oxide, etc.), various inorganic materials (e.g., glasses, etc.), fibers (e.g., glass fibers, carbon fibers, cellulose fibers, polymer fibers, alumina fibers, etc.), metal powders (e.g., copper, aluminum, boron, silicon, etc.), metalloids, organic materials, graphite, graphene, diamond/nano-diamond, can be blended with h-BN powders. In one embodiment, a filler is chosen from borides, such as titanium di-boride.

In one embodiment, the boron nitride loading is less than 1 wt %.

### BRIEF DESCRIPTION OF THE DRAWINGS

FIG. 1 illustrates an image of boron nitride grade PT110 before mechanical exfoliation;

FIG. 2 illustrates an image of boron nitride in Example 1 of Table 2 after mechanical exfoliation;

FIG. 3 illustrates an image of boron nitride in Example 2 of Table 2 after mechanical exfoliation;

FIG. 4 illustrates an image of boron nitride in Example 3 of Table 2 after mechanical exfoliation; and

FIG. 5 illustrates an image of boron nitride in Example 4 of Table 2 after mechanical exfoliation;

### DETAILED DESCRIPTION

The present subject matter provides high aspect ratio boron nitride particles and compositions comprising such particles. The high aspect ratio particles can provide compositions with a wide range of excellent properties making them suitable for various applications including thermal management, electrical insulation, barrier for gases and moisture, optical properties, lubrication, etc. High aspect ratio boron nitride can provide compositions with good thermal conductivity and other desirable properties at relatively low boron nitride loadings compared to currently available alternate boron nitride materials.

In one aspect, the present subject matter provides high aspect ratio boron nitride particles. Boron nitride particles comprise crystalline or partially crystalline boron nitride produced with boron nitride platelets or highly delaminated boron nitride powders.

Aspect ratio is defined as the ratio of the largest to smallest dimension of the particle. In this context, the particles referred to are platy or disc shaped as opposed to fibers or with a fibrous morphology. Thus, aspect ratio as used herein refers to the diameter of the discs divided by the thickness of these particles. As used herein, high aspect ratio boron nitride refers to boron nitride, e.g., BN platelets, having aspect ratios greater than 300. The phrase high aspect ratio boron nitride particles, BN nanoflakes and BN nanosheets may be used interchangeably in this context.

The aspect ratio referred to here is the calculated average aspect ratio of the platy particles. It is calculated based on volume average particle size and surface area measurements:

$$AR = \frac{D}{t} = \frac{S ρ D}{2} - 2$$

where, AR is the aspect ratio, D is the diameter of the platelet (average particle size, D50 in this case), t is the thickness of the platelets, S is the surface area of the particles, and ρ is the density of the platelets.

Higher aspect ratio particles provide better thermal conductive pathways by minimizing thermal interfaces via multiple conductive pathways for similar weight loadings compared to lower aspect ratios; such interfaces are a key barrier for realizing good thermal conductivity. This behavior is further enhanced in larger crystals (diameter or x-y size) compared to smaller diameter crystals, and heat conduction (via phonon transfer in the case of h-BN) occurs over larger distances without interruption.

In one embodiment, the boron nitride particles have an average aspect ratio of greater than 300. In one embodiment, the boron nitride particles have an average aspect ratio of about 305 to about 2500, about 310 to about 2000, about 325 to about 1500, about 350 to about 1000, even about 400 to 800. In one embodiment, the aspect ratio is from about 320 to about 2350. In an embodiment, the aspect ratio is from about 305 to about 800. In still another embodiment, the aspect ratio is about 305 to 500. Here as elsewhere in the specification and claims, numerical values can be combined to form new and non-disclosed ranges.

The high aspect ratio boron nitride particles comprise hexagonal boron nitride (h-BN). Such h-BN particles allow for either an h-BN only filled system or a system comprising multiple fillers that also includes high aspect ratio h-BN.

The boron nitride particles can have a diameter (evaluated in the x-y dimension of the particle) of from about 0.1 microns to about 500 microns, from about 1 micron to 50 microns, from about 5 microns to about 20 microns, even from about 10 microns to about 15 microns. Here as elsewhere in the specification and claims, numerical values can be combined to form new and non-disclosed ranges.

The boron nitride particles can have a surface area from about 25 m²/g to about 500 m²/g, about 10 to about 2500 m²/g, about m²/g to about 200 m²/g, or about 20 m²/g to about 1000 m²/g. In one embodiment, the boron nitride particle has a surface area of from about 5 to about 20 m²/g. Here as elsewhere in the specification and claims, numerical values can be combined to form new and non-disclosed ranges.

In one embodiment, the boron nitride particles have a powder tap density ranges from about 0.05 g/cc to about 1.5 g/cc, about 0.1 g/cc to about 1 g/cc, even about 0.1 g/cc to about 0.5 g/cc. Here as elsewhere in the specification and claims, numerical values can be combined to form new and non-disclosed ranges.

The high aspect ratio BN can be derived or produced from a variety of boron nitride starting materials. The high aspect BN can be chosen from a variety of starting materials, including but not limited to, semi-crystalline or turbostratic boron nitride having randomly oriented layers (referred to as t-BN); boron nitride with crystalline layered hexagonal structure (referred to as h-BN); or a combination of two or more thereof. In one embodiment, the boron nitride is chosen from a turbostratic form, agglomerate form, crystalline platelet form, or mixtures of two or more thereof.

In another embodiment, the boron nitride particles have an oxygen content from 0.01 to 5 wt %, 0.05 to 3 wt %, 0.1 to 2 wt %, 0.2 to 0.6 wt. %. In another embodiment, the h-BN particles have a graphitization index of less than to, less than 7, further still, less than 2.

In one embodiment, the boron nitride component may comprise crystalline or partially crystalline boron nitride particles made by known processes, such as a highly delaminated boron nitride powder, or boron nitride particles of a platelet morphology made by other suitable methods.

The various features of the particles can be tailored depending on the application of the h-BN. For example, where in-plane thermal conductivity is the priority, the morphology can be chosen with a high aspect ratio while maintaining large x-y dimensions. Where optical transparency is also desired, very high aspect ratios and smaller x-y dimensions may be chosen to minimize scattering effects. Similar appropriate selections can be made for barrier properties, lubrication, and other applications. Additional properties such as surface area, tap density, wettability of the boron nitride particles by the matrix, processability, etc., can be considered when selecting boron nitride for an intended application.

In one embodiment, based on the application of the boron nitride particles, one property may be traded for another depending on the relative importance. For example, a larger x-y dimension and lower surface area may be considered as an alternate to very high aspect ratios to provide processability in a polymer while maintaining adequate thermal conductivities.

In one embodiment for a composite system (solid or liquid) comprising h-BN, several features that can be considered include dispersion of the particles and particle coupling with the matrix. These features can be enhanced by additional surface treatments and functionalizing that provide good coupling with the matrix, provide uniform and stable dispersions, and minimize thermal interface resistance.

The high aspect ratio boron nitride can be made by several different processes including different exfoliation processes. In one embodiment, a process for making high aspect ratio boron nitride in accordance with the present subject matter includes mechanical exfoliation of h-BN particles. For example, high aspect ratio h-BN platelets can be made by applying mechanical shear to h-BN platelets suspended in a carrier. The carrier can be in a liquid form, a solid form, or a combination of solid and liquid phases. Examples of suitable liquid carriers include, but are not limited to, aqueous suspensions, organic solvents, organic liquids, oils, molten polymers, silicones, molten salts, other low melting point systems, etc. Examples of suitable solid carriers include, but are not limited to, powders comprising organic compounds, polymer powders or pellets below its glass transition temperature (Tg), at the Tg, and/or above Tg, etc., inorganic powders such as ceramic and glass powders, metals, etc., and combinations of liquid and solid systems.

Optionally, the h-BN platelets can be treated prior to mechanical exfoliation to enhance susceptibility for exfoliation. For example, in one embodiment, mechanical shear is applied on the h-BN platelets via a kneading block mixer in a molten polymer. In another embodiment, the BN is treated with surface treatment agents to enable better coupling with matrix and then subjected to mechanical exfoliation. In another embodiment, h-BN is mixed with corn syrup in a centrifugal mixer and then further mixed with kneading blocks to apply shear in a high shear mixer. In another embodiment, h-BN is mixed with thermoplastic pellets and subjected to high shear in an extrusion machine at temperatures above the Tg. In another embodiment, h-BN powder is extruded in a thermoplastic polymer at temperatures below the Tg with active cooling of the barrels. In another embodiment, h-BN is mixed with de-ionized water and subjected to shear via a micro-fluidization via high pressure flow through micro-channels. In another embodiment, h-BN platelets are suspended in liquids such as isopropanol, butanols, ethylene glycol, glycerin, and subjected to high shears in the micro-fluidization machine. In another embodiment, boron nitride is suspended in vegetable oil into a paste like slurry and subjected to high shear in a three-roll mill with multiple passes to exfoliate the boron nitride. In another embodiment, the h-BN platelets are mixed with epoxy monomers and subjected to high shear in a three roll mill.

In one embodiment, h-BN is stirred in a heated mixture of concentrated sulfuric acid, nitric acid, and/or potassium permanganate for 6 hours at 60° C. The resultant mixture is then washed with deionized water (DI) water and sonicated for 2 hours using an ultrasound horn to generate h-BN nano flakes. In another embodiment, the mixture obtained after hot stirring is subjected to thermal shock without washing at 1200° C. under flowing nitrogen. In another embodiment, the material is washed and filtered, and this material is reconstituted in DI water to form a thick paste and is run through a 3 roll mill to mechanically exfoliate the h-BN crystals. In yet another embodiment, the mixture is reconstituted in an epoxy matrix without hardener and exfoliated in a 3-roll mill.

In another process of chemical exfoliation, h-BN is sonicated for 15 minutes and then stirred in hot ammonium chloride solution for 7 days at 90° C. in a closed vessel. In one embodiment this resultant mixture is subjected to thermal shock at 1200° C. in flowing nitrogen. In another embodiment, this mixture is subjected to mechanical shear in a 3-roll mill. In another embodiment, the mixture is subjected to high shear applied via a kneading block mixer in a molten poly-carbonate matrix.

In another embodiment of chemical exfoliation, h-BN is blended with equal parts of aluminum nitrate and mixed in DI water and stirred for 2 days at 95° C. in a closed vessel. This mixture is then subjected to thermal shock forming exfoliated h-BN; alumina is formed as a byproduct. In one embodiment, this resulting thermal shocked h-BN and alumina mixture is sonicated for 15 minutes in DI water using an ultrasound horn. In another embodiment, the mixture is mixed with polycarbonate matrix and subjected to high shear in a kneading block mixer while the polymer is melted.

In still another embodiment of chemical exfoliation, h-BN is placed in a pressure vessel with ammonium hydroxide 40% solution and heated for 2 hours at 90 psi and 100° C. In one embodiment, the resulting mixture is thermally shocked in a furnace at 1200° C. In another embodiment, the mixture after thermal shock is reconstituted in silicone oil and subjected to high shear in a 3-roll mill to further exfoliate the h-BN. In another embodiment, the mixture out of the pressure vessel is washed, dried, and reconstituted in a thick corn-syrup and placed in a kneading block mixer where it is subjected to high shear mixing. In yet another embodiment, the chemically intercalated mixture is placed in an extruder with a PET matrix and is subjected to a high shear extrusion process with mixing elements chosen for imparting high shear while minimizing cutting action that would destroy the crystal diameter of the h-BN.

In another embodiment, h-BN is mixed with aluminum sulfate and DI water and heated to 85° C. in atmospheric pressure for 5 days with a condenser to minimize loss of water via evaporation. The mixture is then washed to remove excess salt. In another embodiment, the above process is performed in an ultra-sonicating bath in a closed container at 85° C. for 24 hours. The resultant mixtures are then reacted with sodium bicarbonate at 60° C. for 12 hours in atmospheric pressure to intercalate and exfoliate the boron nitride. The resulting material is then subjected to thermal shock at 1200° C. in nitrogen in one embodiment.

In additional embodiments, the resulting exfoliated h-BN samples from the above embodiments are reconstituted in propylene glycol to form a paste and further mechanically exfoliated in a 3-roll mill.

Thermal exfoliation methods may also be used with chemical exfoliation methods to prepare the h-BN composition. In one embodiment, h-BN is subjected to intercalation and then to high temperature thermal shock where intercalants decompose inside the boron nitride layers causing the h-BN layers to exfoliate. Intercalants may be chosen from chemical intercalation approaches. The thermal shock temperatures can range from 800° C. and above as achieved via furnaces, microwave plasmas, a plasma spray, or other type of thermal spray processes.

Electro-chemical exfoliation methods can also be chosen to form an h-BN composition. In one embodiment, h-BN is subjected to intercalating agents or electrolytes in the presence of electrochemical fields to enhance intercalation. This process enables intercalants to penetrate the boron nitride layers as it is difficult to intercalate and exfoliate h-BN.

In one embodiment, intercalated boron nitride is then subjected to additional exfoliation via mechanical methods or thermal shock processes. In one embodiment, intercalants are chosen from the following group, be in a liquid state at the processing conditions (for example molten at elevated temperatures), or a combinations of the above. Examples of such intercalants include, but are not limited to, chlorides, fluorides, sulfates, carbonates, phosphates, nitrates, chalcogenides, and mixtures of two or more thereof. Specific examples include lithium nitrate, sodium carbonate, potassium carbonate, aluminum sulfate, aluminum nitrate, zinc chloride, etc. Examples of organic compounds include octa-decyl-amine, poly(sodium-4-styrenesulfonate), ethylene carbonate, etc. The above examples are non-limiting embodiments of such electrolytes.

The starting h-BN particles employed for exfoliation may be chosen based on a particular size and shape to ensure a desired size and shape of the final exfoliated h-BN. Also, the final h-BN morphology may be controlled by selecting the starting h-BN and the process used for exfoliation. In one embodiment, the particle size can range from nanometers to micron size particles. In one embodiment, the boron nitride powder has an average particle size of about 0.1 μm to about 50 μm; from about 5 μm to about 20 μm; from about to 10 μm to about 15 μm. In one embodiment, the boron nitride powder has an average particle size of at least 50 μm. Here, as elsewhere in the specification and claims, numerical values can be combined to form new and non-disclosed ranges.

The present subject matter also provides compositions comprising the high aspect ratio boron nitride particles. The high aspect ratio boron nitride particles can be incorporated into various matrix systems, including, but not limited to, silicones; thermoplastics, such as polyethylene, polypropylene, nylon, polycarbonate, PET, PBT, etc.; thermosets, such as epoxies, phenolics, rubber, or a combination of the above matrices either as miscible or immiscible mixtures; liquids, such as oils, water, organics, or a combination of these; greases, pastes, and suspensions; other organics; metals; metalloids; inorganic materials such as ceramics, glasses, etc.; or a combination of two or more thereof.

The high aspect ratio can be present in an amount as desired to provide the composition with properties for a particular purpose or intended application. In the embodiments, the high aspect ratio boron nitride material is present in an amount of from about 0.1 weight percent to about 60 weight percent, from about 1 weight percent to about 40 weight percent, even from about 5 weight percent to about 20 weight percent. Here as elsewhere in the specification and claims, numerical values can be combined to form new and non-disclosed ranges.

In one embodiment, at least 25% of the boron nitride particles in the composition have an aspect ratio of 300 or greater. In one embodiment, at least 30%; at least 40% at least 50% at least 75%, even at least 90% of the boron nitride particles have an aspect ratio of 300 or greater. Here as elsewhere in the specification and claims, numerical values can be combined to form new and non-disclosed ranges.

The h-BN can be surface treated to provide specific groups on the surface that may then be directly used with any one or more of the above material systems, or additionally functionalized to provide properties any one or a combination of the following: better coupling with the matrices, stability of suspension during processing and afterwards, modify rheology, minimize interface losses for improving thermal conductivity, improve optical properties, improve mechanical properties. Examples of suitable materials to treat the boron nitride particles include, but are not limited to, organics such as epoxy monomers, silanes, silicones, various other classes of functionalization additives that include organometallic compounds such as titanates and zirconates (Ken-react by Kenrich), aluminates, hyperdispersants (Solsperse by Lubrizol), maleated oligomers such as maleated polybutadiene resin or styrene maleic anhydride copolymer (Cray Valley), fatty acids or waxes and their derivatives, oleates, and ionic or non-ionic surfactants that either physisorbed, or chemisorbed, reactively such as ionically or covalently, or otherwise bonded with BN surfaces. These functionalization additives may be used at 0.5 wt % to about 15 wt % of fillers; or from about 3 to 12 wt %; even from about 5 to 10 wt % of the fillers.

In one embodiment, the silane additive can be chosen from an alkacryloxy silane, a vinyl silane, a halo silane (e.g., a chlorosilane), a mercapto silane, a blocked mercaptosilane, a thiocarboxylate silane, or a combination of two or more thereof. In one embodiment, the thermally conductive compositions can comprise from about 0.5 to about 10 wt. % of a silane; from about 1.5 to about 4 wt. %; even from about 2.7 to about 3.7 wt. % of the fillers.

In one embodiment, the silane can be represented by Y—R¹—Si(R²)ₙ(R³)₃₋ₙ, wherein Y represents R⁴R⁵N—, R⁷R⁸N—R⁶—NR⁴—, or R¹¹R¹⁰N—R⁹—R⁷N—R⁶—NR⁴—; or Y and R¹(Y—R¹) conjointly represent a vinyl group, an alkyl group, a phenyl group, a 3,4-epoxycyclohexyl group, a halogen atom, a mercapto group, an isocyanate group, a thiocarboxylate group, an optionally substituted glycidyl group, a glycidoxy group, an optionally substituted vinyl group, a methacryloxy group (CH₂═C(CH₃)COO—), an acryloxy group (CH₂═CHCOO—), a ureido group (NH₂CONH—), an optionally substituted methacryl group, an optionally substituted epoxy group, an optionally substituted phosphonium halide group, an optionally substituted ammonium halide group, or an optionally substituted acryl group; R⁴, R⁵, R⁷, R⁸, R¹⁰ and R¹¹ independently represent a hydrogen atom or a C₁-C₆ alkyl group; R⁶ and R⁹ independently represent a C₂-C₆ alkylene group; R, is a single bond, an alkylene group, or a phenylene group; or R¹ and Y (Y—R¹) conjointly represent a vinyl group; each R² independently represents an alkyl group or a phenyl group; each R³ independently represents a hydroxy group or an alkoxy group; and n is an integer of 0 to 2).

Suitable vinyl silanes include are those having the formula: R¹²SiR¹³ₙY(₃₋ₙ), where R¹² is an ethylenically unsaturated hydrocarbyl, hydrocarbyloxy, or (meth)acryloxy hydrocarbyl group, R¹³ is an aliphatic saturated hydrocarbyl group, Y is independently a hydrolysable organic group, and n is 0, 1 or 2. In one embodiment Y is an alkoxy group of an alkyl having from 1 to 6 carbon atoms, such as methoxy, ethoxy, propoxy and butoxy. In one embodiment, R¹² can be chosen from vinyl, allyl, isoprenyl, butenyl, cyclohexyl, or (meth)acryloxy propyl; Y can be chosen from methoxy, ethoxy, formyloxy, acetoxy, propionyloxy, or an alkylamino or arylamino group; and R¹³, if present, can be chosen from a methyl, ethyl, propyl, decyl, or phenyl group.

In one embodiment, the silane is a compound of the formula CH₂═CHSi(OA)₃ (2) where A is a hydrocarbyl group having 1 to 8 carbon atoms, and in one embodiment 1 to 4 carbon atoms.

In one embodiment, the silane is chosen from octanoylthio-1-propyltriethoxy silane; vinyl tris(2-methoxy-ethoxy)silane; vinyl trimethoxy silane, vinyl triethoxysilane gamma-methacryloxypropyltreimethoxy silane, vinyl triacetoxy silane, or a combination of two or more thereof. Examples of suitable silanes include, but are not limited to, those available from Momentive Performance Materials and sold under the tradename NXT. NXT is a thiocarboxylate silane and an example of the broader class of blocked mercaptosilanes. Suitable silanes also include those described in U.S. Pat. Nos. 6,608,125; 7,078,551; 7,074,876; and 7,301,042.

Other suitable fillers can be blended with the high aspect ratio h-BN particles to provide additional enhancements to properties such as thermal conductivity, mechanical strengthening, enhanced optical properties, and others. Examples of suitable fillers include, but are not limited to, ceramic powders (e.g., alumina, silica, aluminum nitride, zinc oxide, magnesium oxide, etc.), various inorganic materials (e.g., glasses, graphite, graphene, diamond, etc.), fibers (e.g., glass fibers, carbon fibers, cellulose fibers, polymer fibers, alumina fibers, carbon nanotubes/nano-fibers, BN nanotubes/nano-fibers, etc.), metal powders (e.g., copper, aluminum, boron, silicon, etc.), organic materials, etc. In one embodiment, the filler is chosen from boron nitride, silica, glass fibers, zinc oxide, magnesia, titania, yttrium oxide, hafnium oxide, calcium carbonate, talc, mica, wollastonite, alumina, aluminum nitride, graphite, metallic powders, e.g., aluminum, copper, bronze, brass, etc., fibers or whiskers of carbon, graphite, silicon carbide, silicon nitride, alumina, aluminum nitride, zinc oxide, nano-scale fibers such as carbon nanotubes, graphene, boron nitride nanotubes, boron nitride nanosheets, zinc oxide nanotubes, etc., complex oxides (a class of materials many of which exhibit strong relationships between the charge, magnetic, and lattice degrees of freedoms, such as perovskite materials); carbon/graphite/diamond/cubic boron nitride, borides such as TiB₂, ZrB₂ or a combination of two or more thereof.

In one embodiment, at least one non-BN filler is present in an amount of from about 0.1 weight percent to about 50 weight percent; from about 2 weight percent to about 25 weight percent; even from about 5 weight percent to about 15 weight percent. Here as elsewhere in the specification and claims, numerical values can be combined to form new and non-disclosed ranges.

In one embodiment, enhanced properties of the h-BN particles may include improved thermal conductivity, heat transfer, electrical insulation, transparency to various wavelengths including optical spectrums, barrier to gas/moisture permeation, lubrication and wear, non-stick properties, neutron absorption and scattering, deep UV emission, mechanical properties, chemical inertness and stability, bio compatibility, high temperature oxidation resistance, high temperature stability, and crystal nucleating agent for polymers.

A high aspect ratio h-BN and corresponding formulations using a high aspect h-BN can be used in numerous applications, such as thermally conductive encapsulants for LEDs that also provide gas and moisture permeation barrier with or without optical transparency, thermal interface materials (TIMs) TIM-I and TIM-2 such as die attaches, underfills, potting compounds, greases, etc., electronics, computers, mobile devices, medical equipment, automotive, industrial, lighting, off-shore, lasers, aerospace, thermoplastics, thermally conductive fluids (thermofluids), structural materials, transparent materials, barrier materials, lubricants, non-stick materials (for applications such as molten metals, glass processing), corrosions prevention, etc.

### Examples

In one example, h-BN was exfoliated using a 3-roll mill in a suitable carrier: hBN with an average crystal size of 50 microns was mixed with various carriers. Any suitable carrier or a combination of carriers from a family of matrices, solvents, surfactants, additives that provide beneficial stiction to the boron nitride surface may be chosen. Organic materials, inorganic materials, or a combination of two or more thereof can be chosen. In this example, honey, corn starch in water, Poly-2-Ethyl 2-Oxazoline in water, and poly vinyl acetate in water solution were used. The hBN was mixed with the solvents at various loadings in a centrifugal mixer first to get a uniform dispersion and then were processed through the 3-roll mill. The 3-roll mill was run with a roll gap of 15 microns with a max speed of 400 RPM. The 3 roll mill was run with at least one, but up to and including multiple passes. The resulting exfoliated BN was then ashed to remove the carrier (organic content). The hBN sample exfoliated with honey had an aspect ratio of 330.

The following results are from mechanical exfoliation via applied shear to starting boron nitride particles in polymeric matrix melts (thermoplastics). In these trials, various polycarbonates are mixed with boron nitride in different experiments, processed in a three-piece melt-mixer with a roller blade configuration at temperature above their melting/softening points. The trials include variables such as boron nitride solids loading, mixing speed, mixing time, mixing temperature, total volume of the mixture, applied torque, molecular weights of the matrices, and additives to improve bonding between a matrix and boron nitride. Trial results are shown below in Table 1:

TABLE 1

| | | | | | | | Melt | | | |
|---|---|---|---|---|---|---|---|---|---|---|
| | | | | | | | Flow | | | |
| | | BN, | | | Mixing | Mixing | Rate, | SA | | Av- |
| Ex- | | wt | BN, | Temp. | Speed | Time | (g/min, | m²/ | D₅₀ | erage |
| ample | Polymer Type | % | vol % | ° C. | RPM | minutes | 300' C.) | gm | μm | AR |
| 1 | Polycarbonate-2 | 60 | 45.21 | 240 | 60 | 16 | 25.4 | 7.41 | 40.11 | 336.8 |
| 2 | Polycarbonate-1 | 60 | 45.21 | 240 | 60 | 30 | 25.4 | 6.54 | 44.86 | 332.5 |
| 3 | Polycarbonate | 70 | 45 | 260 | 100 | 40 | 7 | 19 | 36 | 793 |

In Table 1, the average aspect ratio is calculated based on volume average particle size and surface area measurements. Aspect ratio is given by the following relation (for platy particles):

$$AR = \frac{D}{t} = \frac{S ρ D}{2} - 2$$

where, AR is the aspect ratio, D is the diameter of the platelet (average particle size, D50 in this case), t is the thickness of the platelets, S is the surface area of the particles, and ρ is the density of the platelets.

Additional trial results from different mechanical exfoliation methods via applied shear to starting BN particles includes the use of different instruments and types of carriers. Trial results are shown below in Table 2:

TABLE 2

| Example | Method | Matrix | SA (m²/gm) | D₅₀ μm | Average AR |
|---|---|---|---|---|---|
| 1 | Brabender | Polycarbonate | 19 | 36 | 793 |
| 2 | 3-roll mill | Honey | 15 | 20 | 333 |
| 3 | Extrusion | Epoxy | 7 | 41 | 324 |
| 4 | Surface treated and | Water based | 147 | 14 | 2322 |
| | mechanical exfoliation | | | | |

Additional trial results from mechanical exfoliation via applied shear (Brabender® double blade batch mixer/compounder with high shear blades) to starting BN particles includes the use of two different polycarbonate matrices (polycarbonate-4 and polycarbonate-5), and one type of boron nitride starting material. Trial results are shown below in Table 3:

| | | | | Mixing | Mixing | | | |
|---|---|---|---|---|---|---|---|---|
| | | BN, | Temp. | Speed | Time | SA | D₅₀ | Calculated |
| Example | Polymer Type | vol % | ° C. | RPM | minutes | m²/gm | μm | AR |
| 1 | Polycarbonate-4 | 45 | 240 | 60 | 16 | 7.41 | 41.2 | 312 |
| | (MFR 25 g/10 min) | | | | | | | |
| 2 | Polycarbonate-4 | 45 | 220 | 60 | 30 | 6.54 | 43.1 | 481 |
| | (MFR 25 g/10 min) | | | | | | | |
| 3 | Polycarbonate-5 | 45 | 240 | 60 | 16 | 5.33 | 40.1 | 337 |
| | (MFR 22 g/10 min) | | | | | | | |
| 4 | Polycarbonate-5 | 45 | 240 | 60 | 16 | 5.33 | 35.4 | 312 |
| | (MFR 22 g/10 min) | | | | | | | |

In these trials, the boron nitride grade is PT110 (with average particle size D50, of approximately 45 μm), the “processed volume” is the cavity volume of the processor or mixer where the sample is processed, SA is the Surface area, D50 is the volume average particle size, AR is the aspect ratio, and MFR is the melt flow rate measured at 300° C.

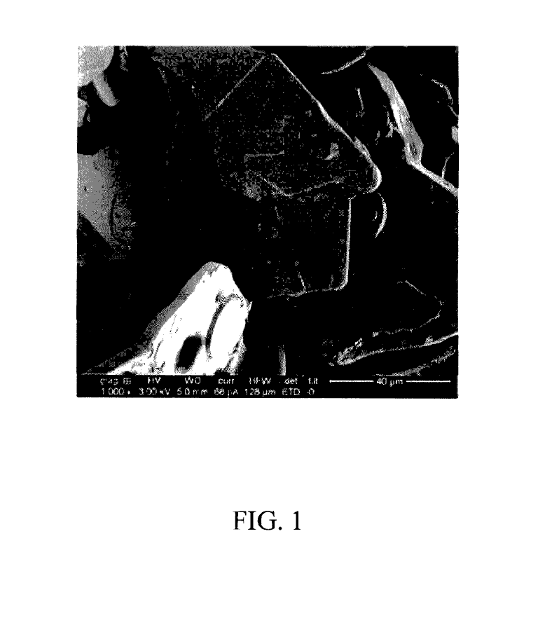

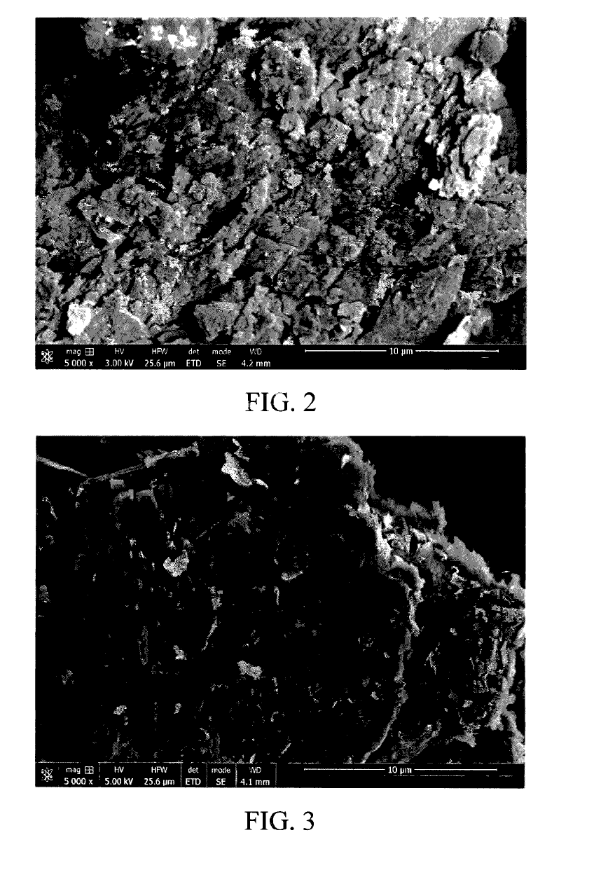

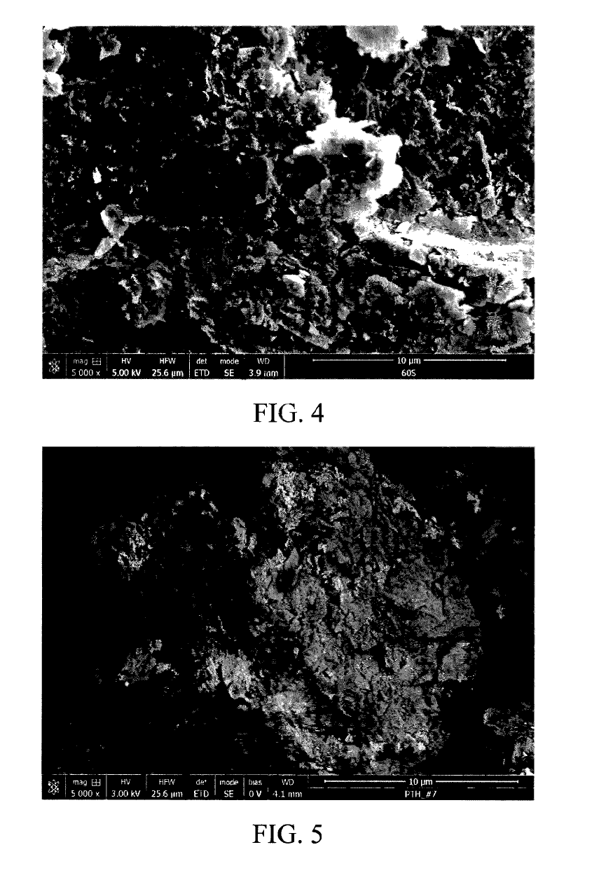

An image of boron nitride grade PT110 is shown in FIG. 1 (before exfoliation); an image of mechanically exfoliated boron nitride (Table 2 Example 1) is shown in FIG. 2; and images after mechanical exfoliation in Table 2, Example 3, 4, and 5 are shown in FIGS. 3, 4, and 5.

Particle size can be measured using a Microtrac (Model #X100) particle size distribution analyzer where the particle to be analyzed (e.g., BN) is introduced in an amount adjusted to meet the required transmission. A few drops of 2% Rhodapex CO-436 can be added to improve the dispersion of the powder, and the particle size can be measured using laser diffraction after a 3 second sonication. The particle size distribution resulting from the measurement can be plotted on a volume basis and the D50 represents the 50th percentile of the distribution.

The specific surface area was measured via ASITM C1069 procedure, with specific degassing procedure for Boron nitride. The calculations of the surface area from this method are based on the Brunauer-Emmett-Teller (BET) equation.

The through-plane thermal conductivity is measured using the laser flash method (ASTM E1461) utilizing the theoretical specific heat capacity (Cp) values based on the composition, where the response to the flash energy is measured & evaluated across the thickness of the sample.

The in-plane thermal conductivity was measured using a modified laser flash method using a special sample holder and an in-plane mask (Netzsch Instruments). For a given composition, both methods of measuring the in-plane thermal conductivity yield comparable results.

The in-plane thermal conductivity was also measured using a hot disk method (Hot Disk) using a sensor sandwiched between 2 samples that acts as a heater and also measures heat loss/decay.

A formulated product can be in the form of a powder that is a final formulation, modifiable by the end user, a master batch, or an intermediary that can be modified to form a master batch or a final formulation.

While the above description contains many specifics, these specifics should not be construed as limitations on the scope of the subject matter, but merely as exemplifications of preferred embodiments thereof. Those skilled in the art may envision many other possible variations that are within the scope and spirit of the subject matter as defined by the claims appended hereto.

1. A composition comprising boron nitride particles with an average aspect ratio of greater than 300.

2. The composition of claim 1, wherein the boron nitride particles have an average aspect ratio of about 305 to about 2500.

3. The composition of claim 1, wherein at least 25% of the boron nitride particles have an average aspect ratio of greater than 300.

4. The composition of claim 1, wherein the boron nitride particles have x-y dimensions in the range of 0.1 microns to 5 millimeters

5. The composition of claim 1, wherein the boron nitride particles have an average particle size of about 0.1 μm to 500 μm.

6. The composition of claim 1, wherein the boron nitride particles comprise h-BN particles having a graphitization index of less than 7.

7. The composition of claim 1, wherein the boron nitride particles have an oxygen content from about 0.05 to about 5 wt. %.

8. The composition of claim 1, wherein the boron nitride particles have a surface area of from about 5 m²/g to about 500 m²/g.

9. The composition of claim 1, wherein the boron nitride particles are chosen from semi-crystalline or turbostratic boron nitride, hexagonal boron nitride, or a combination of two or more thereof.

10. The composition of claim 1, wherein the boron nitride particles are chosen from, turbostratic boron nitride, platelet hexagonal boron nitride, agglomerated boron nitride particles, or a combination of two or more thereof.

11. The composition of claim 1, wherein the composition further comprises a polymer chosen from a thermoset material, a thermoplastic material, or a combination thereof.

12. The composition of claim 11, where in the composition comprises a total boron nitride loading from about 0.1 wt % to 75 wt %.

13. The composition of claim 1, wherein the composition further comprises a filler chosen from boron nitride; silica; glass fibers; zinc oxide; magnesia; titania; yttrium oxide; hafnium oxide; calcium carbonate; talc; mica; wollastonite; alumina; aluminum nitride; metallic powders, such as aluminum, copper, bronze, brass; fibers or whiskers of carbon, graphite, silicon carbide, silicon nitride, alumina, aluminum nitride, zinc oxide; nano-scale fibers, chosen from carbon nanotubes/nano-fibers, cellulose fibers, graphene, boron nitride nanotubes/nano-fibers, zinc oxide nanotubes/nano-fibers; oxides belonging to the alkaline and alkaline earth elements; transition metal oxides; oxides from post-transition metals; oxides from metalloids; oxides from the lanthanide and actinide series of elements; complex oxides; carbides belonging to transition elements; carbides belonging to metalloid elements; carbides belonging to lanthanide and actinide series of elements; nitrides belonging to transition elements; nitrides belonging to post transition elements; nitrides belonging to metalloid elements; nitrides belonging to the lanthanide and actinide series of elements, metals, metalloids, carbon; or a combination or two or more of any of these materials.

14. The composition of claim 1, wherein the composition has a through-plane thermal conductivity of at least 0.3 W/mK at a loading of 25 wt % BN or less.

15. The composition of claim 1, wherein the composition has an in-plane thermal conductivity of at least 0.3 W/mK at a loading of 25 wt % BN or less.

16. The composition of claim 1, wherein the composition has a through-plane thermal conductivity from about 0.3 W/mK to 30 W/mK.

17. The composition of claim 1, wherein the composition has an in-plane thermal conductivity from about 0.3 W/mK to 30 W/mK.

18. The composition of claim 1, wherein the composition further comprises a fluid chosen from an oil, water, an organic, or a combination of two or more thereof, with or without other BN and non-BN fillers.

19. The composition of claim 1, wherein the composition further comprises a metal or a combination of metals/alloys thereof, with or without other BN and non-BN fillers.

20. The composition of claim 1, wherein the composition further comprises an inorganic matrix chosen from a ceramics, a boride, a glass, or a combination of two or more thereof, with or without other BN and non-BN fillers.

21. The composition of claim 1, wherein the composition further comprises a fibrous preform chosen from cellulose, BN fibers, glass fibers, or a combination of two or more thereof, with or without other BN and non-BN fillers.

22. The composition of claim 1 comprising a matrix material chosen from chosen from a siloxane, a silane, a polyesters, a vinyl polymer, an acrylate, a urethane, an epoxy, a polyamide, a polyimide, a polyamidimide, a polycarbonate, a polypthalamide, a polysulfone, a polyetheretherketone, a thermoplastic polyurethane, a fluoropolymer, a fluoroelastomer, a chlorofluoropolymer, a chloropolymers, a phenol-formaldehyde resin, an aramid polymer, a melamine resin, a polyethylene terephthalate, or a combination of two or more thereof

23. A process for making high aspect ratio boron nitride particles, the process comprising treating a boron nitride starting material under mechanical shear suspended in a carrier, wherein the carrier is in a liquid form, a solid form, or a combination of solid and liquid phases to produce boron nitride particles having an average aspect ratio greater than 300.

24. The process of claim 23, wherein the boron nitride particles have an average aspect ratio of about 300 to about 2500.

25. The process of claim 23, wherein at least 20% of the boron nitride particles have an average aspect ratio of greater than 300.

26. The process of claim 23, wherein the boron nitride particles are chosen from platelet hexagonal boron nitride, turbostratic boron nitride, agglomerated boron nitride particles, or a combination of two or more thereof.

27. The process of claim 23, wherein mechanical shear is applied to the BN particles in the carrier via processes chosen from extrusion, kneading, fluid flow in micro-channels, or a combination of two or more thereof wherein shear forces are more prominent than impact or other type of forces.

28. The process of claim 23, wherein the boron nitride starting material is pre-treated prior to mechanical exfoliation.

29. The process of claim 23, wherein treating the boron nitride starting material comprises subjecting the boron nitride starting material to a chemical exfoliation process.

30. A boron nitride particle having an average aspect ratio of 300 or greater.

31. The boron nitride particle of claim 30, wherein the boron nitride particles have an average aspect ratio of about 305 to about 2500.

32. The boron nitride particle of claim 30, wherein the boron nitride particle is treated with a surface treatment agent, chosen from a surface functional agent, a coupling agent, a dispersant, or a combination of two or more thereof.

33. The boron nitride of claim 32, wherein the surface treatment agent is chosen from an epoxy monomer, a silane, a silicone, a zirconate, an oleate, a phosphate, or a combination of two or more thereof.

34. The boron nitride of claim 33, wherein the surface treatment agent comprises a silicone, silane chosen from an alkacryloxy silane, a vinyl silane, a halo silane, a mercapto silane, a thiocarboxylate silane; a blocked mercapto silane; 3-octanoylthio-1-propyltriethoxy silane, vinyl tris(2-methoxy-ethoxy)silane, gamma-methacryloxypropyltreimethoxy silane, mercaptosilane; an alkacryloxy silane; a vinyl silane; a halo silane; a thicaraboxylate silane; or a combination of two or more thereof.

35. An article comprising the composition of claim 1.

36. The article of claim 35, wherein at least a portion of the article is formed from the composition.

37. The article of claim 34 wherein the composition is disposed on at least a portion of a surface of the article.

38. The article of any of claim 35, wherein the article is chosen from
any one or a combination of the following: encapsulants for LEDs, blends into the phosphor layer, blends into the remote phosphor, and blends into the encapsulant layer in LEDs, thermal interface materials (TIMS), solid-state device packaging materials, photon-conversion layers, phosphorescent materials, transparent materials, diffuse/scattering materials, reflective and whitening agents (reflection of all color), LED packaging substrates with similar CTE as silicone encapsulants enabling minimizing delamination failures, polymer housings for luminaires, heat sinks, thermofluids, structural materials, gas/vapor/moisture barrier materials, thermoelectric materials, electronics, computers, mobile devices, medical equipment, automotive, industrial, lighting, off-shore, lasers, and aerospace.
